(19) United States
(12) Patent Application Publication
(10) Pub. No.: US 2015/0287433 A1
(43) Pub. Date: Oct. 8, 2015

(54) SYSTEM AND METHOD OF GENERATING STATIC CONTIGUOUS MEDIA FORMATS FROM DYNAMIC PLAYLISTS

(71) Applicant: Rocky Williform, Atlanta, GA (US)

(72) Inventor: Rocky Williform, Atlanta, GA (US)

(21) Appl. No.: 14/676,280

(22) Filed: Apr. 1, 2015

Related U.S. Application Data
(60) Provisional application No. 61/975,232, filed on Apr. 4, 2014.
(60) Provisional application No. 62/076,045, filed on Nov. 6, 2014.

(51) Int. Cl. G11B 20/10

(52) U.S. Cl. CPC G11B 20/10527; G11B 2020/10537

(57) ABSTRACT

The present invention generally relates to systems and methods for generating a new type of media format. Specifically, embodiments of the present invention are configured to provide users the ability to generate a MixP3 format by integrating various media formats into a proprietary file format. A user is able to use the system to select media formats, arrange them in any desired order, and combine them into a single contiguous format. In other embodiments, the system may be provided with a source playlist to use to convert into the MixP3 format. When playback is requested, the MixP3 format plays the media formats as one contiguous media playback with no breaks in between tracks. Moreover, the MixP3 format may be unalterable, similar to a traditional music album.

### CROSS REFERENCE TO RELATED APPLICATIONS

The present application claims benefit to U.S. Provisional Patent Application No. 61/975,232 filed Apr. 4, 2014 and U.S. Provisional Patent Application No. 62/076,045, filed Nov. 6, 2014, the entire disclosures of both are incorporated herein by reference.

### FIELD OF THE INVENTION

The present invention generally relates to systems and methods for generating a new type of media format. Specifically, embodiments of the present invention are configured to provide users the ability to generate a MixP3 format by integrating various media formats into a proprietary file format. A user is able to use the system to select media formats, arrange them in any desired order, and combine them into a single contiguous format. In other embodiments, the system may be provided with a source playlist to use to convert into the MixP3 format. When playback is requested, the MixP3 format plays the media formats as one contiguous media playback with no breaks in between tracks. Moreover, the MixP3 format may be unalterable, similar to a traditional music album.

### BACKGROUND OF THE INVENTION

Music and music distribution has become largely based on and effected through distributed electronic systems providing digital tracks over communications networks (e.g., the Internet). The days of the majority of individuals going to a record or music store to purchase hardcopies (e.g., CDs, cassette tapes, vinyl records) of albums are long gone. With the demise of the records store has also come the decline/demise of the purchasing of music in album format. More commonly, individuals now stream or download individual tracks from artists that they like.

In many cases, artists created albums so that they would be listened to in a particular order as the arrangement of the music may be as important as the individual tracks themselves. This is true not just for original artists, but also creators of complications of music, frequently known as a “Mixtape” (alternatively, “Mix-Tape” or “Mix Tape”). The albums and mixtapes string together multiple tracks to create an overall effect for the entire work. This may include build ups, breakdowns, telling a story via the tracks in a particular, or any combination thereof.

Unfortunately, however, now with the digital and streaming focus of most music services, these arrangements are not maintained as users will cherry pick tracks they want to hear and skip over the organization that was originally intended by the artist. This is made even easier with digital and streaming tracks as users can instantly jump to any track or point in a track (e.g., specific time) instead of listening to the whole work through. The same is true with video content, with users able to jump to different points in a video or between videos with ease.

In this manner, the art of the album or compilation is being lost in today's modern music provision and consumption services. No restrictions are placed on these systems or services with respect to playback of media content (e.g, audio, video) and users are able to consume as they see fit as opposed to how the original artist(s) intended.

Therefore, there is a need in the art for a system and method for providing fixed format media files that incorporate numerous media formats under restrictive playback settings. These and other features and advantages of the present invention will be explained and will become obvious to one skilled in the art through the summary of the invention that follows.

### SUMMARY OF THE INVENTION

Accordingly, embodiments of the present invention are directed to a system and method for providing fixed format media files that incorporate numerous media formats under restrictive playback settings.

According to an embodiment of the present invention, a system for generating a restrictive media file from one or more media formats comprises: a restrictive media file generation module comprising computer executable code stored in non-volatile memory; a processor; a memory; and a communications means, wherein said restrictive media file generation module, said processor, said memory, and said communications means are operably connected and are configured to: receive a request for generation of a restrictive media file from a plurality of media files; identify each of said media files of said plurality of media files via one or more identifiers associated with said plurality of media files provided in said request; generate organizational data for said plurality of media files, wherein organizational data comprises an order for playback of each individual media file as identified in said request; generate said restrictive media file from said plurality of media files and said organizational data, wherein said restrictive media file effects the playback of said plurality of media files as dictated by said organizational data in a manner where consumption of the restrictive media file is restricted on one or more playback restrictions.

According to an embodiment of the present invention, the playback restrictions are selected from the group consisting of: restricted time fast-forwarding, restricted time rewinding, restricted time selection, restricted track selection, restricted track skipping and restricted track rewinding.

According to an embodiment of the present invention, once said restrictive media file is generated, it is secured such that further revisions to the restrictive media file are prevented.

According to an embodiment of the present invention, the restrictive media file generation module, said processor, said memory, and said communications means are further configured to: receive a second request for generation of restrictive media file from a second plurality of media files; identify an overlap between said request and said second request, wherein said plurality of media files matches said second plurality of media files; and terminate said second request due to said overlap.

According to an embodiment of the present invention, the restrictive media file generation module, said processor, said memory, and said communications means are further configured to: identify second organizational data for said second plurality of media files, wherein said second organizational data comprises an order for playback of each individual media file as identified in said second request; and identify an overlap between said second organizational data and said organizational data.

According to an embodiment of the present invention, the restrictive media file comprises meta-data identifying a retrieval location for each of the plurality of media files and data related to said one or more playback restrictions.

According to an embodiment of the present invention, the restrictive media file generation module, said processor, said memory, and said communications means are further configured to publish said restrictive media file for consumption by one or more remote users.

According to an embodiment of the present invention, the restrictive media files is secured such that said one or more playback restrictions are applied during playback regardless of the playback means.

According to an embodiment of the present invention, the restrictive media file is provided to a remote computing device of a user for consumption on said remote computing device independent of any remote system.

According to an embodiment of the present invention, the restrictive media file generation module, said processor, said memory, and said communications means are further configured to disable functionality of said remote computing system with respect to playback options in contravention to said one or more playback restrictions.

According to an embodiment of the present invention, a method of generating a restrictive media file from one or more media formats comprises the steps of: receiving a request for generation of a restrictive media file from a plurality of media files; identifying each of said media files of said plurality of media files via one or more identifiers associated with said plurality of media files provided in said request; generating organizational data for said plurality of media files, wherein organizational data comprises an order for playback of each individual media file as identified in said request; generating said restrictive media file from said plurality of media files and said organizational data, wherein said restrictive media file effects the playback of said plurality of media files as dictated by said organizational data in a manner where consumption of the restrictive media file is restricted on one or more playback restrictions.

According to an embodiment of the present invention, the method further comprises the steps of: receiving a second request for generation of restrictive media file from a second plurality of media files; identifying an overlap between said request and said second request, wherein said plurality of media files matches said second plurality of media files; and terminating said second request due to said overlap.

According to an embodiment of the present invention, the method further comprises the steps of: identifying second organizational data for said second plurality of media files, wherein said second organizational data comprises an order for playback of each individual media file as identified in said second request; and identifying an overlap between said second organizational data and said organizational data.

According to an embodiment of the present invention, the method further comprises the step of publishing said restrictive media file for consumption by one or more remote users.

According to an embodiment of the present invention, the method further comprises the step of disabling functionality of said remote computing system with respect to playback options in contravention to said one or more playback restrictions.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3A is an exemplary schematic of a system for generating a restrictive media file from one or more media formats, in accordance with an embodiment of the present invention;

FIG. 3B is an exemplary schematic of a system for generating a restrictive media file from one or more media formats, in accordance with an embodiment of the present invention;

FIG. 4 is an illustration of an exemplary process flow, in accordance with an embodiment of the present invention; and

FIG. 5 is an illustration of an exemplary process flow, in accordance with an embodiment of the present invention.

### DETAILED SPECIFICATION

The present invention generally relates to generation of digital media content based on underlying standard media content. Specifically, embodiments of the present invention are configured to a system and method of generating a new type of digital media file format known as MixMP3 having a .mixp3 file extension. The terms MixMP3, MixP3, and mixp3 all refer to this new digital media file format and shall be regarded as equivalent terms throughout this application. A mixp3 type file of the present invention may include, but is not limited to, extended play (EP), long play (LP), or extended long play (ELP) compilations of digital media formats selected and arranged by a user and stored as a .mixp3 file. Fans, disc jockeys, and artists can use the system of the present invention to create their own compilation of music based on their own individual taste, across artists, genre and labels and the EP, LP, or ELP. The customized compilation of music can then be stored as a single compressed MixP3 format with the .mixp3 file extension.

According to an embodiment of the present invention, a media format could be selected from one or more media content types. Media formats include, but are not limited to, audio tracks, videos, multimedia files, 3D content, or any combination thereof. In a preferred embodiment, media formats may be selected from the group comprising audio tracks, streaming audio tracks, streaming video content, video file content, audio files, or any combination thereof. One of ordinary skill will appreciate that the MixP3 format is not limited to use of any particular media formats and may include other types of media formats.

One of the advantages of this new type of media file format is that selection of an EP, LP, or ELP release is no longer limited to industry professionals and artists. Rather, the system and method of the present invention allow fans to create their own custom music compilations in the form of an EP, LP, or ELP.

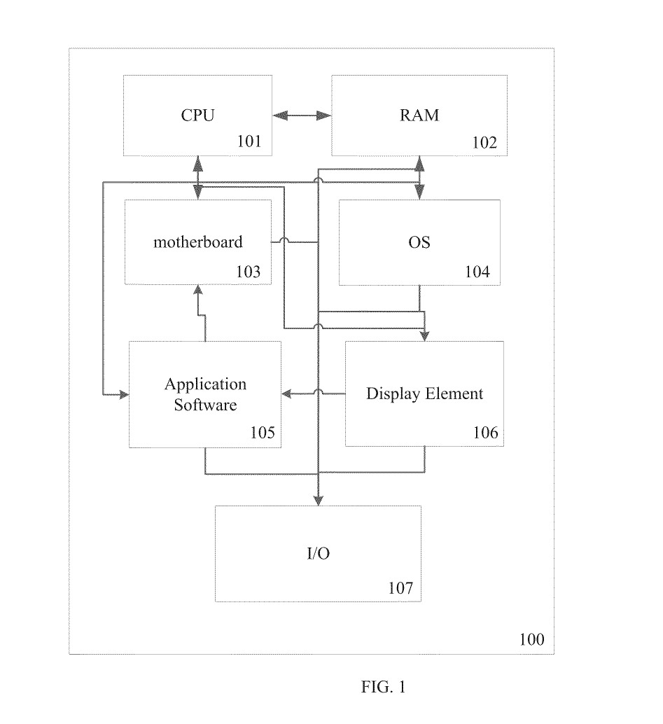

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

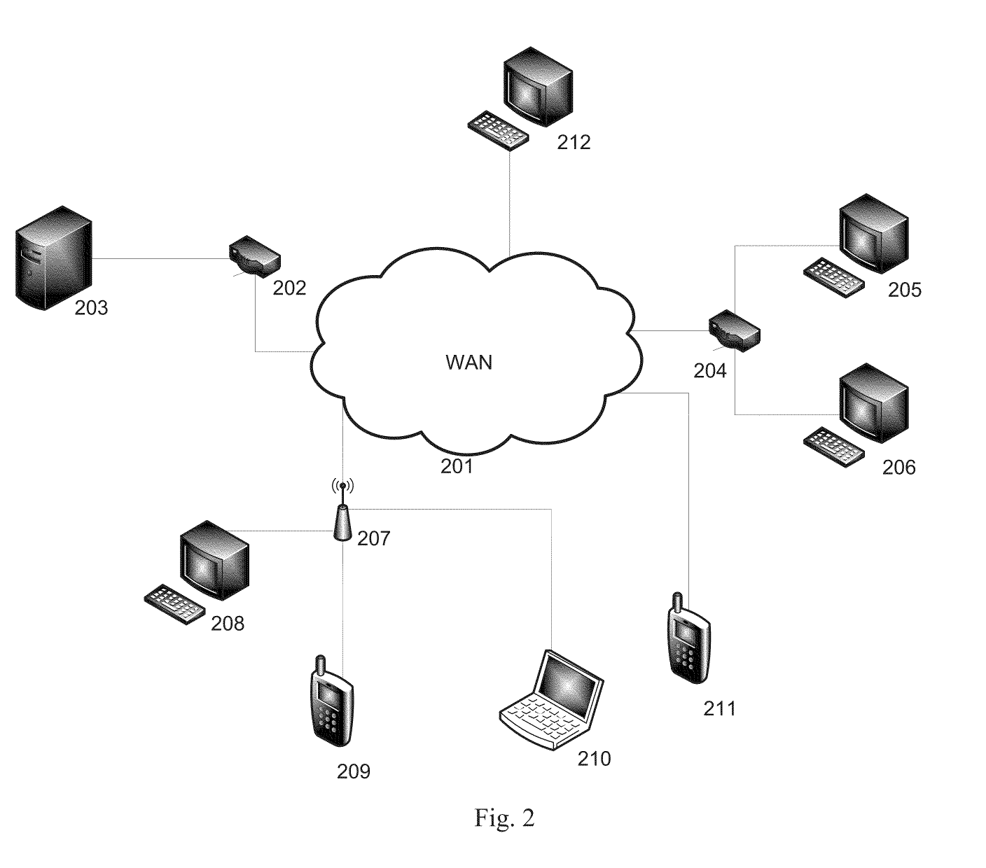

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

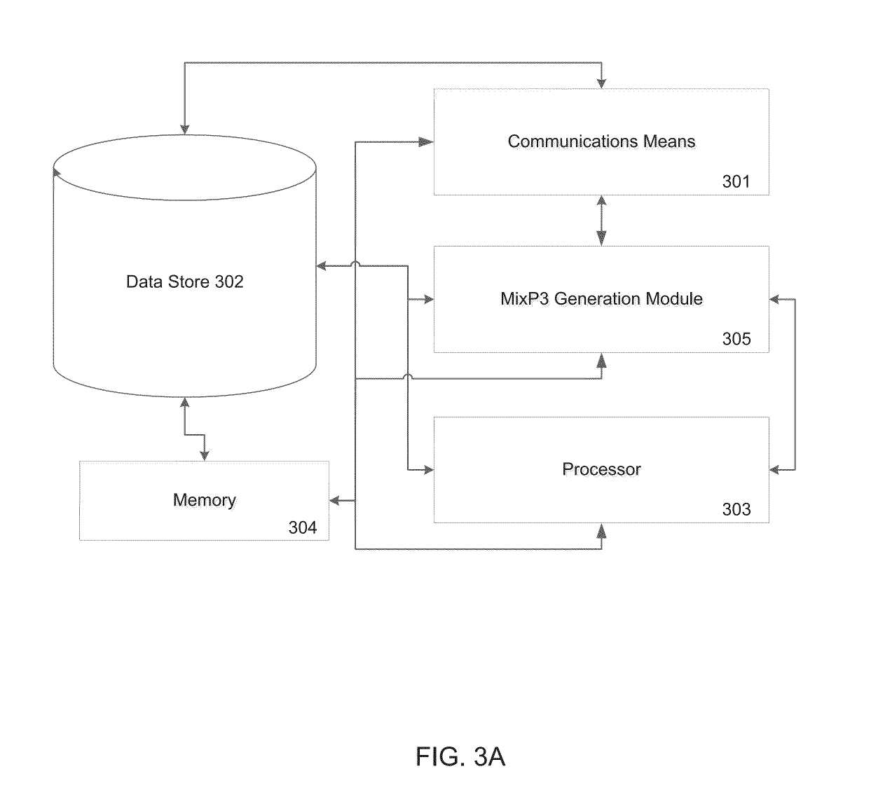

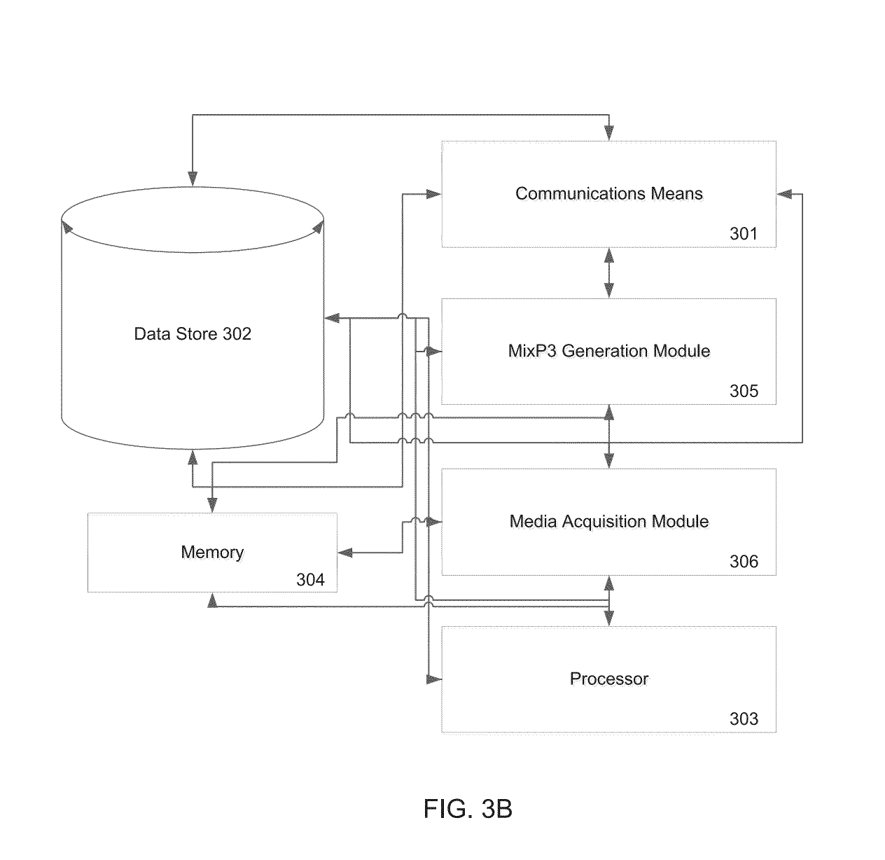

Turning to FIG. 3A, according to an embodiment of the present invention, a system for generating MixP3 files is comprised of one or more communications means 301, one or more data stores 302, a processor 303, memory 304, and a MixP3 Generation Module (also referred to herein as a “Restrictive Media File Generation Module”) 305. FIG. 3B shows an alternative embodiment of the present invention, comprised of one or more communications means 301, one or more data stores 302, a processor 303, memory 304, a MixP3 Generation Module 305 and a Music Acquisition Module 306. The various modules described herein (e.g., MixP3 Generation Module 305 and Music Acquisition Module 306) provide functionality to the system, but the features described and functionality provided may be distributed in any number of modules, depending on various implementation strategies. One of ordinary skill in the art would appreciate that the system may be operable with any number of modules, depending on implementation, and embodiments of the present invention are contemplated for use with any such division or combination of modules as required by any particular implementation. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks or to one or more peripheral devices attached to the system. Appropriate communications means may include, but are not limited to, wireless connections, wired connections, cellular connections, data port connections, Bluetooth® connections, or any combination thereof. One of ordinary skill in the art would appreciate that there are numerous communications means that may be utilized with embodiments of the present invention, and embodiments of the present invention are contemplated for use with any communications means.

The present invention generally relates to digital media file formats. In particular, embodiments of the present invention are configured to provide a new type of digital media file format known as .mixp3. The new file format may include EP, LP, or ELP compilations of media formats selected and arranged by a user and stored as a single mixp3 file. The mixp3 file may be stored and played on a computing device, or streamed from one network connected computing device to another.

In a preferred embodiment of the present invention, the system is comprised of one or more servers configured to manage the transmission and receipt of content and data between users and recipients. The users and recipients may be able to communicate with the components of the system via one or more mobile computing devices or other computing device connected to the system via a communication method supplied by a communication means (e.g., Bluetooth, WIFI, CDMA, GSM, LTE, HSPA+). The computing devices of the users and recipients may be further comprised of an application or other software code configured to direct the computing device to take actions that assist in the generation and transmission of messages as well as the recording and transmission of reactions. Components of the system act as an intermediary between the computing devices of the users and the recipients.

According to an embodiment of the present invention, the system is configured to enable a user to generate mixp3 format by selecting media formats and arranging them in a preferred order. A user is thus able to create a customized album of music from selected artists, genres, and labels. The customized music compilation of the mixp3 format is different from a playlist, because the music compilation is created as one contiguous media format. Therefore, individual media formats cannot be altered, added, deleted or otherwise amended, similar to an album CD or DVD. In certain embodiments, the MixP3 format of the invention may be a read-only file or employ some other software means to prevent alteration of the file. In these embodiments, once the MixP3 file is generated, it can be made available for sale, consumption (e.g., playback) or transfer.

In another preferred embodiment, the system may be configured to maintain a cloud repository of all the possible tracks available for inclusion in a MixP3 format, with each track having a unique identifier (e.g., GUID). When a user wishes to convert a playlist into a MixP3 format, the system will scan the playlist to identify relevant information (e.g., track titles, artists names) for each track in the playlist. Identification can be done via the aforementioned unique identifier. Once all the tracks have been selected and identified, the system will assign a separate unique identifier for the MixP3 format being created to associate the tracks in the source playlist and convert the source playlist into a MixP3 metadata file (a preferred format for the MixP3 format) which can be stored locally or remotely (e.g., stored in a cloud storage system or other network storage system). Each time the MixP3 metadata file is requested for playback, the system will first identify all of the tracks in the MixP3 metadata file and then put them into a memory (e.g., cache memory), so each track can be easily accessed as the MixP3 format plays from track to track contiguously. It should be noted that this MixP3 metadata file format plays with the same restrictions as the read-only file format, in that alterations are not permitted and other playback restrictions will apply (e.g., no skipping tracks).

In certain embodiments, the system can receive a source playlist from a third-party source (e.g., SPOTIFY, ITUNES, GOOGLE PLAY). For instance, a user can direct the system to retrieve a playlist stored on one of these third-party sources. In turn, the system can retrieve (such as through an API provided by the third-party source) and convert the source playlist into a MixP3 using information provided in the source playlist in order to identify the necessary tracks and generate the MixP3 format therefrom. In other embodiments, the source playlist may be generated through users interacting with the system and developing the source playlist directly on the system. One of ordinary skill in the art would appreciate that there are numerous ways that source playlists could be generated or provided to the system, and embodiments of the present invention are contemplated for use with any appropriate method for receiving or generating playlists.

According to an embodiment of the present invention, the unique identifier for a mixP3 metadata file will work across all compatible platforms. For a platform to become compatible, its tracks can be checked against a database or other data store accessible to the system and be assigned master universal MixP3 identifier.

According to an embodiment of the present invention, the MixP3 format may be configured in different ways, such as a traditional album, an EP, LP or ELP. An EP consists of 5 to 10 tracks, an LP consists of more than 10 and up to 30 tracks, and an ELP consists of more than 30 tracks, which could include bonus tracks.

In one preferred embodiment, the MixP3 format includes at least 5 tracks, and may include 30 or more tracks. Furthermore, in this embodiment, the tracks of the MixP3 format are not separate, distinct files. Rather, the tracks are integrated into one contiguous digital media file. Consequently, individual tracks cannot be added or removed once the MixP3 file is created.

In another preferred embodiment, the MixP3 format is a metadata file containing information for retrieval of multiple tracks to be played as a single contiguous media format. Similar to the single MixP3 file format, tracks cannot be later added or removed once the metadata file is finalized.

In certain embodiments, the system may allow for the inclusion of metadata within the MixP3 format. For instance, the MixP3 format can include, but is not limited to, metadata related to information about the tracks contained in the MixP3, album art, artist information, track information, information about restrictions on the MixP3 (e.g., no fast-forward, no rewind), title of the MixP3, or any combination thereof. One of ordinary skill in the art would appreciate that there are numerous types of information that could be included in the MixP3 format, and embodiments of the present invention are contemplated for use with any appropriate type of information. Further, each piece of information could be contained directly in the MixP3 format or referenced by way of a link or other remote identifier (e.g., uniform resource locator (URL)).

The MixP3 file protocol will conform to ISO (International Organization for Standardization) standards, so that it will be compatible with platforms configured to play other types of media files. For example, the MixP3 format may be played by MP3/MP4 media players such as Windows Media Player® or RealPlayer®, however the MixP3 is played as one contiguous media file with no breaks in between tracks.

In a preferred embodiment, the MixP3 file may be played on a specially designed media player or platform configured to play MixP3 files. The MixP3 player of the invention is a proprietary mobile music service available at MixP3.com and may be downloaded as a MixP3 app (i.e. application) for Apple, Android, Windows, Linux, and other operating systems. Furthermore, the MixP3 platform may include necessary functionality to generate MixP3 files from selected media formats. The platform includes a GUI configured to allow a user to easily retrieve and/or select digital media formats from various sources and compile them into a MixP3 format. The MixP3 platform described herein comprises a set of computer readable instructions that may reside in memory and are executable by the CPU of a computing device, or several distributed computing devices.

According to an embodiment of the present invention, a MixP3 is one contiguous format generated from one or more media formats joined together in an arrangement chosen by a user. However, as previously discussed, the MixP3 format is preferably at least 5 media formats selected by the user. Further, the MixP3 format generated may include use restrictions that prevent deletion, skipping, fast forwarding, rewinding or editing the tracks. Once the media formats are integrated into a MixP3 format they may be permanently fixed, similar to a traditional EP, LP, ELP or album released to the public.

According to an embodiment of the present invention, the system may be configured to prevent duplicate MixP3 format's from being generated. For instance, once a user has generated a MixP3 format with Tracks A, B, C, D, E in that order, no other user can generate the same MixP3 format with Tracks A, B, C, D, E in that order. The system may be configured to notify users attempting to generate a duplicate MixP3 format of the existence of the previously generated MixP3 format and provide the user the ability to purchase or otherwise download the previously generated MixP3 format. This works to give original authors credit for their MixP3 format generation as well as limit system utilization for duplicate works. This feature may be provided by way of a Sequence Redundancy Detection System (SRDS).

According to an embodiment of the present invention, the SDRS may be a part of the MixP3 format and the system can be configured to run a query against a MixP3 repository to detect and prevent the duplication of MixP3 files being created. When a MixP3 file consisting of the same tracks+same sequence is arranged, the SRDS will automatically detect the duplicate nature of the newly requested MixP3 format, flag the duplicate, and disallow the creation of the source playlist into a new MixP3 format. In this manner, every unique playlist will be converted into a MixP3 only once.

According to an embodiment of the present invention, the system may be configured to store and retrieve music for use in generation of a MixP3 format. Users may be allowed to search for media formats stored by the system for use in a MixP3 format. In certain embodiments, users may also be allowed to provide their own media formats for use in a MixP3 format.

According to an embodiment of the present invention, the system may further be configured to remove whitespace or other gaps between media formats when generating a MixP3 format to allow for seamless transition between media formats when collapsed into a MixP3 format.

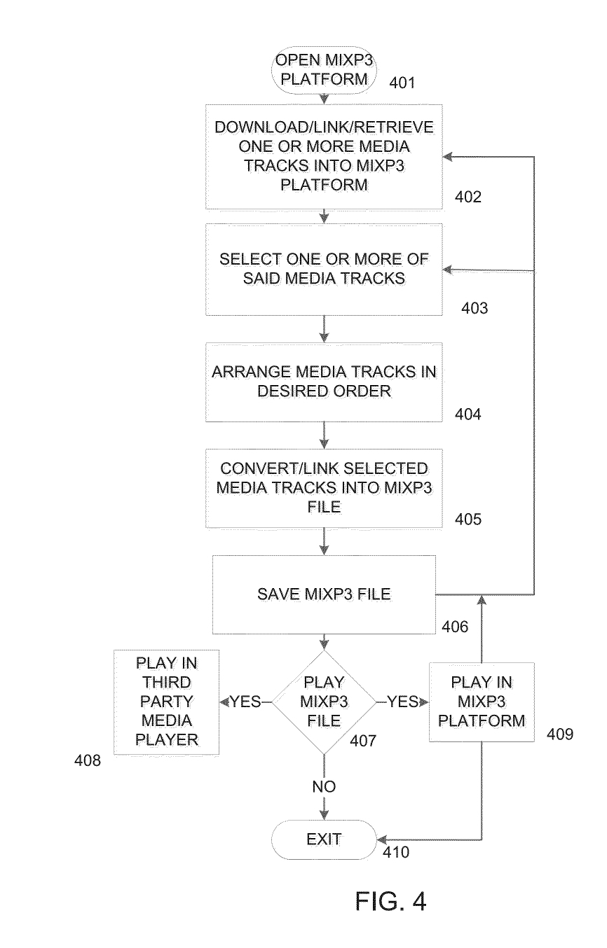

Turning now to FIG. 4, an exemplary method for preparing a MixP3 format request is shown. The process starts at step 401 with a user accessing the MixP3 platform via a computing device (e.g., smartphone, desktop, laptop, tablet PC). In certain embodiments, access to the MixP3 platform on the user's computing device may require access to information/data provided from a remote portion of the system (e.g., application server) in order to provide the full suite of options and functionality. In other embodiments, a client side MixP3 platform may not require access to a remote system and have full functionality incorporated onto the computing device of the user. One of ordinary skill in the art would appreciate that there are numerous distributions that could be utilized with respect to the requirement for data and services to be provided locally versus over a remote system, and embodiments of the present invention are contemplated for use with any appropriate distribution of functional components and aspects of the system.

At step 402, the MixP3 platform accesses media for use in the generation of a MixP3 format. Access to media may include, but is not limited to, retrieving media files from one or more local storage mediums, retrieving or accessing media files from one or more remote storage mediums, retrieving or accessing media files or meta-data associated with media files (i.e., information required to retrieve streaming content upon request after formation of the MixP3 format) from one or more streaming services, or any combination thereof. One of ordinary skill in the art would appreciate that there are numerous ways in which to access and/or retrieve media files and/or meta-data for accessing streaming content, and embodiments of the present invention are contemplated for use with any appropriate method for accessing/retrieving media files and/or meta-data for accessing streaming content. It should also be noted that accessing and retrieving of the media file and/or meta-data for accessing streaming content may also include accessing and/or retrieving meta-data or other data associated with the media file, such as performing artist, composer, track name, album name, track length, year performed, year composed, label owning copyright, track producer and other credits, album artwork, cover artwork, band members names, band member information, track identifier (e.g., GUID), or any combination thereof. One of ordinary skill in the art would appreciate that there are numerous types of meta-data and other associated data that could be utilized with embodiments of the present invention, and embodiments of the present invention are contemplated for use with any appropriate meta-data and/or other associated data.

At step 403, the user selects one or more available media formats for use in the MixP3 format. Selection of the media formats may depend on the type of computing device utilized by the user. For instance, selection of media formats on a smartphone with a capacitive interface may be done through a series of touches, swipes, pinches or other tactile inputs on the capacitive interface in a manner that identifies the tracks desired by the user. On a laptop, a combination of mouse, keyboard or other pointer device inputs could be utilized to identify the desired tracks. One of ordinary skill in the art would appreciate that there are numerous methods for identifying and selecting the one or more tracks for use with the MixP3 format, and embodiments of the present invention are contemplated for use with any appropriate method for making such identification/selection.

At step 404, the MixP3 platform provides an interface for the user to arrange the tracks in an order desired by the user. Similar to selecting media formats, the interface for arranging the tracks may vary depending on computing device and/or application type (e.g., mobile app v. web browser). In preferred embodiments of the invention, organization of the tracks is important to the process as the MixP3 format is a fixed format in that once finalized, the organization is unchangeable.

At step 405, after selection and organization of the media formats by the user, the user submits the completed request to the system, comprising the media format selection and organization data. In certain embodiments, the request may also include options with respect to the restrictions placed on playback, where available. Upon receipt of the request, the system generates the MixP3 format as described herein.

At step 406, the system saves the generated MixP3 format. As described herein, the MixP3 format can be stored in any number of manners. For instance, a MixP3 format may be a single file comprising the media data, organization data, restriction data and any other necessary or optional information. In other embodiments, the MixP3 format may comprise meta-data allowing for the retrieval of necessary data for playback (e.g., media date, organization data, optional information). In still further embodiments, the MixP3 format may be comprised of both data stored locally and data to be retrieved upon request. For instance, the MixP3 format may incorporate media data locally and comprise meta-data allowing for the retrieval of optional information, such as album art. One of ordinary skill in the art would appreciate that there are numerous ways the data for the MixP3 format could be distributed between local and remote storage, and embodiments of the present invention are contemplated for use with any appropriate distribution of data for the MixP3 format.

At step 407, the MixP3 format is ready for playback, playback may be accomplished via a third-party video/media player (step 408) or in the MixP3 Platform (step 409). Otherwise, the process can terminate at step 410. When played in a third-party video/media player, the MixP3 Format may include instructions or security measures that implement the restrictions on playback incorporated with the MixP3 format. By disabling features that would break the playback restrictions, the MixP3 format maintains its purpose across multiple platforms. Disabling features may be implemented through interactions with the third-party player or with a lower level process (e.g., operating system). One of ordinary skill in the art would appreciate that there are numerous methods for providing the disabling of features in software, and embodiments of the present invention are contemplated for use with any appropriate method.

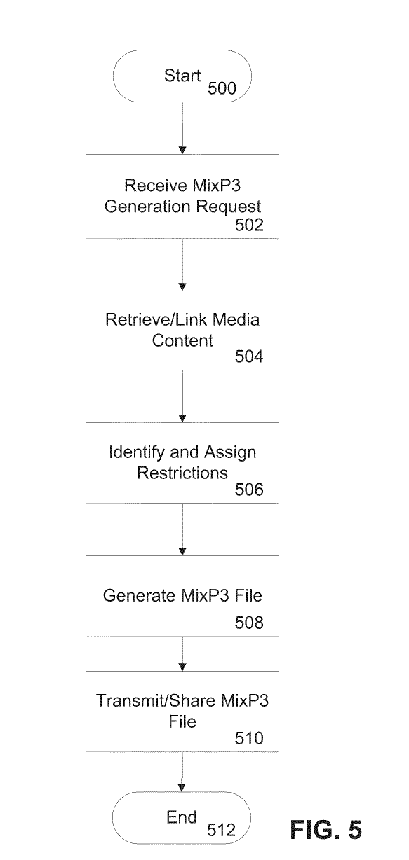

Turning now to FIG. 5, an exemplary method for processing a MixP3 format request at the MixP3 system/platform is shown. The process starts at step 500 with the system receiving a interaction from a user related to the generation of a MixP3 format. At step 502, the system receives a MixP3 generation request (e.g., from step 405 above). The MixP3 generation request comprises all the information provided from a user with respect to the formation of a MixP3 format (e.g., media format selection, meta-data associated with access information required for any streaming content, organization of media formats, optional restriction settings). With the generation request, the system can affect the processing of the MixP3 format.

At step 504, the system retrieves the music content (i.e., media formats) to be used in or associated with the MixP3 format or otherwise associates streaming access data (e.g., meta-data for accessing streaming content) for the music content to be associated with the MixP3 format. As described herein, the system may retrieve the media format files for MixP3 formats that are intended to include the media formats directly in the MixP3 format or retrieve and include meta-data that will allow for the retrieval of the media content on demand (e.g., via an media streaming means), or any combination thereof (e.g., some media content included in the MixP3 format and other media content associated via meta-data and will be pulled for playback in a streaming format). One of ordinary skill in the art would appreciate that there are numerous methods for retrieving the music content/media formats for use in the MixP3 format, and embodiments of the present invention are contemplated for use with any appropriate method and means for such retrieval.

At step 506, the system identifies any restrictive playback features contained in the generation request. As described herein, a standard MixP3 format will restrict standard playback functionality to only linear playback (e.g., no rewinding, no fast forwarding, no skipping tracks), however optional restrictions may be selected in addition to or in lieu of the standard restrictions. Once the system has identified the appropriate restrictions (either standard or optionally selected restrictions), the system will assign those restrictions for use in the generation of the MixP3 format.

At step 508, the system uses the information provided and processed to format and generate the MixP3 format. Generation of the MixP3 format formalizes and finalizes the MixP3 format into a final form. As discussed herein, preferred embodiments of the final MixP3 format are unchangeable. Further, once generated, the system may also store references to the media formats and organization of the MixP3 format to prevent future duplicates being created. As noted herein, preferred embodiments of the system maintain a listing of all formed MixP3 formats in order to identify and prevent future duplications of MixP3 formats. This helps protect the author of the original MixP3 format as well as conserve space and reduce processing requirements for duplicative MixP3 formats.

At step 510, the system transmits and/or shares the MixP3 format as identified in the generation request. This may be via transmission of the resulting MixP3 format to the requesting user, sharing the MixP3 format via the system or via a third-party social media platform, or any combination thereof. One of ordinary skill in the art would appreciate that there are numerous methods for sharing and transmitting completed files, and embodiments of the present invention are contemplated for any appropriate means and methods for sharing and transmitting the MixP3 format accordingly. At this point, the process terminates at step 512.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for generating a restrictive media file from one or more media formats, the system comprising:
a restrictive media file generation module comprising computer executable code stored in non-volatile memory;
a processor;
a memory;
and a communications means,
wherein said restrictive media file generation module, said processor, said memory, and said communications means are operably connected and are configured to:
receive a request for generation of a restrictive media file from a plurality of media files;
identify each of said media files of said plurality of media files via one or more identifiers associated with said plurality of media files provided in said request;
generate organizational data for said plurality of media files, wherein
organizational data comprises an order for playback of each individual media file as identified in said request;
generate said restrictive media file from said plurality of media files and said organizational data, wherein said restrictive media file effects the playback of said plurality of media files as dictated by said organizational data in a manner where consumption of the restrictive media file is restricted on one or more playback restrictions.

2. The system of claim 1, wherein said playback restrictions are selected from the group consisting of: restricted time fast-forwarding, restricted time rewinding, restricted time selection, restricted track selection, restricted track skipping and restricted track rewinding.

3. The system of claim 1, wherein once said restrictive media file is generated, it is secured such that further revisions to the restrictive media file are prevented.

4. The system of claim 1, wherein said restrictive media file generation module, said processor, said memory, and said communications means are further configured to:
receive a second request for generation of restrictive media file from a second plurality of media files;
identify an overlap between said request and said second request, wherein said plurality of media files matches said second plurality of media files; and
terminate said second request due to said overlap.

5. The system of claim 3, wherein said restrictive media file generation module, said processor, said memory, and said communications means are further configured to:
identify second organizational data for said second plurality of media files, wherein said second organizational data comprises an order for playback of each individual media file as identified in said second request;
identify an overlap between said second organizational data and said organizational data.

6. The system of claim 1, wherein said restrictive media file comprises meta-data identifying a retrieval location for each of the plurality of media files and data related to said one or more playback restrictions.

7. The system of claim 1, wherein said restrictive media file generation module, said processor, said memory, and said communications means are further configured to publish said restrictive media file for consumption by one or more remote users.

8. The system of claim 1, wherein said restrictive media files is secured such that said one or more playback restrictions are applied during playback regardless of the playback means.

9. The system of claim 1, wherein said restrictive media file is provided to a remote computing device of a user for consumption on said remote computing device independent of any remote system.

10. The system of claim 9, wherein said restrictive media file generation module, said processor, said memory, and said communications means are further configured to disable functionality of said remote computing system with respect to playback options in contravention to said one or more playback restrictions.

11. A method of generating a restrictive media file from one or more media formats, the method comprising the steps of:
receiving a request for generation of a restrictive media file from a plurality of media files;
identifying each of said media files of said plurality of media files via one or more identifiers associated with said plurality of media files provided in said request;
generating organizational data for said plurality of media files, wherein organizational data comprises an order for playback of each individual media file as identified in said request;
generating said restrictive media file from said plurality of media files and said organizational data, wherein said restrictive media file effects the playback of said plurality of media files as dictated by said organizational data in a manner where consumption of the restrictive media file is restricted on one or more playback restrictions.

12. The method of claim 11, wherein said playback restrictions are selected from the group consisting of: restricted time fast-forwarding, restricted time rewinding, restricted time selection, restricted track selection, restricted track skipping and restricted track rewinding.

13. The method of claim 11, wherein once said restrictive media file is generated, it is secured such that further revisions to the restrictive media file are prevented.

14. The method of claim 11, further comprising the steps of:
receiving a second request for generation of restrictive media file from a second plurality of media files;
identifying an overlap between said request and said second request, wherein said plurality of media files matches said second plurality of media files; and
terminating said second request due to said overlap.

15. The method of claim 14, further comprising the steps of:
identifying second organizational data for said second plurality of media files, wherein said second organizational data comprises an order for playback of each individual media file as identified in said second request;
identifying an overlap between said second organizational data and said organizational data.

16. The method of claim 11, wherein said restrictive media file comprises meta-data identifying a retrieval location for each of the plurality of media files and data related to said one or more playback restrictions.

17. The method of claim 11, further comprising the step of publishing said restrictive media file for consumption by one or more remote users.

18. The method of claim 11, wherein said restrictive media files is secured such that said one or more playback restrictions are applied during playback regardless of the playback means.

19. The method of claim 11, wherein said restrictive media file is provided to a remote computing device of a user for consumption on said remote computing device independent of any remote system.

20. The method of claim 19, further comprising the step of disabling functionality of said remote computing system with respect to playback options in contravention to said one or more playback restrictions.
